(19) United States
(12) Patent Application Publication
(10) Pub. No.: US 2011/0227503 A1
(43) Pub. Date: Sep. 22, 2011

(54) SYSTEM AND METHOD FOR LED BACKLIGHT DRIVER FOR LCD PANELS

(75) Inventors: ShanShan Yuan, Shanghai (CN); XinFeng Liu, Shanghai (CN); XuGuang Zhang, Shanghai (CN)

(73) Assignee: BCD Semiconductor Manufacturing Limited, George Town (KY)

(21) Appl. No.: 12/766,667

(22) Filed: Apr. 23, 2010

(30) Foreign Application Priority Data
Mar. 17, 2010 (CN) 201020134560.3

(51) Int. Cl. H05B 41/36

(52) U.S. Cl. 315/294

(57) ABSTRACT

A power supply control system for driving light-emitting diode (LED) loads includes a first power switch for coupling to a voltage source, and a plurality of second power switches, each of which is configured for coupling to one of a corresponding plurality of LED loads. Each of the LED loads can include multiple light-emitting diodes (LEDs) connected in series. The power supply control system also includes an integrated circuit controller that includes a voltage controller configured to control the first power switch to provide an output voltage to each of the LED loads, and a current controller configured for coupling to each of the plurality of second power switches to provide a current through each of the LED loads. The integrated circuit controller is provided in a low-voltage integrated circuit chip, and the first power switch and the plurality of second power switches are high-voltage devices external to the low-voltage integrated circuit chip.

### CROSS-REFERENCES TO RELATED APPLICATIONS

This application claims priority to Chinese Patent Application No. 201020134560.3, filed Mar. 17, 2010, entitled “An LED Backlight driver apparatus for LCD,” by inventors Shanshan YUAN, Xinfeng LIU, and Xuguang ZHANG, which is commonly owned and incorporated by reference in its entirety herein.

### BACKGROUND OF THE INVENTION

Embodiments of the present invention relate generally to integrated circuit techniques. More specifically, embodiments of the invention include techniques for LED (light-emitting diode) driving circuits and systems. Merely by way of example, embodiments of the invention have been applied to LED backlight driver circuits and systems for liquid crystal display (LCD) panels. But it would be recognized that embodiments of the invention have a much broader range of applicability. For example, the techniques described here can be used in driving complex LED lighting system for various applications.

With the development of electronic technology, more and more electronic devices adopt LCD as display. As a kind of backlight source, light-emitting diode (LED) has many advantages, such as long lifetime, high efficiency, and no toxic material. As a result, LEDs are becoming increasingly popular as a backlight source.

At present, conventional solutions for LED backlight driver for LCD panels may follow one of two types. In a first type, a power switch is configured for coupling to a plurality of LED loads in parallel. Each LED load may have multiple light-emitting diodes connected in series. In a second type, an integrated circuit controller is configured for coupling to each one of a plurality of LED loads to control the current flow in each LED load.

As described further below, conventional LED backlight drivers have many limitations. These limitations include, for example, lack of LED current matching, inconsistency of LED brightness, and costly manufacturing process, etc.

Therefore, improved backlight driver methods and devices would be highly desirable.

### BRIEF SUMMARY OF THE INVENTION

Embodiments of the present invention include an LED driver system having a low-voltage integrated circuit controller chip that can be used with external power devices to provide controlled voltages and currents to a plurality of LED loads. Each of the LED loads can be connected in parallel, and each of the LED loads can include multiple LEDs connected in series. Such a system can provide accurately matched current and consistent lighting brightness. These embodiments can provide a high performance LED backlight driver solution for high-voltage LCD panels.

According to an embodiment of the present invention, a power supply control system for driving light-emitting diode (LED) loads includes a first power switch for coupling to a voltage source and a plurality of second power switches, each of which is configured for coupling to one of a corresponding plurality of LED loads. Each of the LED loads can include multiple light-emitting diodes (LEDs) connected in series. The power supply control system includes an integrated circuit controller that has a voltage controller configured to control the first power switch to provide an output voltage to each of the LED loads, and a current controller configured for coupling to each of the plurality of second power switches to provide a current through each of the LED loads. The integrated circuit controller is provided in a low-voltage integrated circuit chip, and the first power switch and the plurality of second power switches are high-voltage devices external to the low-voltage integrated circuit chip.

In an embodiment of the above power supply control system, the current controller includes a current control circuit for controlling each of the plurality of second power switches. In another embodiment, each current control circuit includes a comparator circuit for comparing a reference voltage with a sensed voltage at a resistor coupled to the respective second power switch.

In an embodiment, the voltage controller includes a pulse width modulation (PWM) control circuit. In another embodiment, the current controller is configured to receive an external PWM control signal.

In another embodiment, the low-voltage integrated circuit chip includes connection pins for connecting to three terminals of each of the plurality of second power switches. In an embodiment, the second power switches are MOSFETs, and the three terminals are the drain terminal, the gate terminal, and the source terminal. In another embodiment, at least one of the second power switches is a bipolar transistor, and the three terminals are the collector terminal, the base terminal, and the emitter terminal.

In another embodiment, the plurality of LED loads are configured for providing backlight for a liquid crystal display (LCD) panel. In another embodiment of the power supply control system, the integrated circuit controller also includes protection circuits configured for detecting one or more of the following conditions:

short circuit between a positive terminal of an LED load to a ground terminal;

short circuit between a negative terminal of an LED load to a ground terminal;

short circuit between a positive terminal and a negative terminal of an LED load;

open circuit in an LED load; and

short circuit in an LED load.

According to another embodiment of the present invention, a power supply controller provided in an integrated circuit chip includes one or more first terminals for coupling to a first power switch that is external to the integrated circuit chip and is coupled to a DC voltage source. The power supply controller also has multiple second terminals for coupling to a plurality of second power switches that are external to the integrated circuit chip, each of the plurality of second power switches being coupled to one of a corresponding plurality of loads. The power supply controller also includes a voltage controller configured to control the first power switch to provide an output voltage to each of the plurality of loads, and a current controller configured for coupling to each of the plurality of second power switches to provide a current to each of the plurality of loads.

According to another embodiment of the present invention, an LED (light-emitting diode) backlight system includes a plurality of LED (light-emitting diode) loads. Each of the LED loads includes multiple light-emitting diodes connected in series. The system also includes a first power switch for coupling to a voltage source and a plurality of second power switches, each of which is configured for coupling to one of the plurality of LED loads. The system also has an integrated circuit controller that includes a voltage controller and a current controller. The voltage controller is configured to control the first power switch to provide an output voltage to each of the LED loads. The current controller is configured for coupling to each of the plurality of second power switches to provide a current through each of the LED loads. In this embodiment, the integrated circuit controller is provided in a low-voltage integrated circuit chip, and the first power switch and the plurality of second power switches are high-voltage devices external to the low-voltage integrated circuit chip.

A further understanding of the nature and advantages of the present invention may be realized by reference to the remaining portions of the specification and the drawings.

### BRIEF DESCRIPTION OF THE DRAWINGS

FIG. 1 is a simplified block diagram illustrating an LED (light-emitting diode) backlight system according to an embodiment of the present invention;

FIG. 2 is a simplified schematic diagram illustrating an LED backlight system according to an embodiment of the present invention;

FIG. 3 is a simplified schematic diagram illustrating an integrated circuit power supply controller according to an embodiment of the present invention;

FIG. 4 is a simplified flowchart illustrating a method for driving an LED load according to an embodiment of the present invention; and

FIG. 5 is a simplified flowchart illustrating a method for short-circuit protection according to an embodiment of the present invention.

### DETAILED DESCRIPTION OF THE INVENTION

As described above, conventional LED driver circuits have notable disadvantages, such as current mismatch between each LED strings and lack of the consistent brightness. In some applications, the LED driver needs to drive multiple LED loads connected in parallel, where each LED loads can have many LEDs, for example, 30 to 80, or more, LEDs connected in series. In such a configuration, the voltage can be as high as 100-300V, or ever higher. Some conventional drivers include high voltage devices in an integrated circuit for controlling the current in multiple LED loads. But this approach increases the cost of fabrication and lacks design flexibility.

Embodiments of the present invention include an LED driver system having a low-voltage integrated circuit controller chip that can be used with external power devices to provide controlled voltages and currents to a plurality of LED loads. The description below will make reference to a series of drawing figures enumerated above. These diagrams are merely an example, which examples, and should not unduly limit the scope of the claims herein. In connection with the various aspects illustrated and described, one of ordinary skill in the art would recognize other variations, modifications, and alternatives.

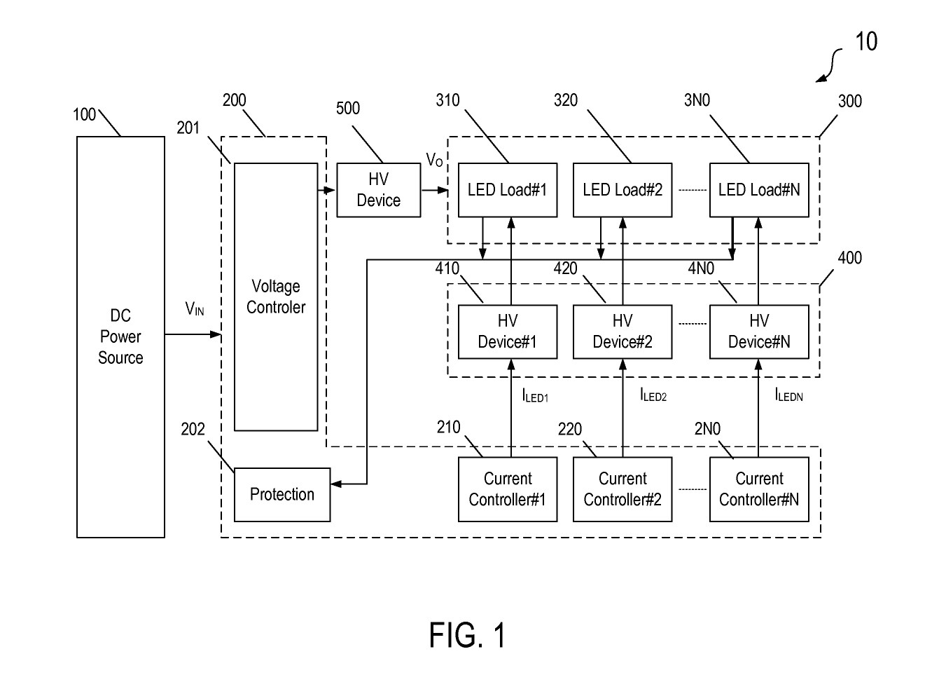

FIG. 1 is a simplified block diagram illustrating an LED (light-emitting diode) backlight system 10 that can be used in an LCD (liquid crystal display) system according to an embodiment of the present invention. As shown, LED backlight system 10 includes a plurality of LED (light-emitting diode) loads labeled 310, 320, . . . , and 3N0, etc. Each of the LED loads includes multiple light-emitting diodes connected in series. A first power switch 500 is coupled to a voltage source 100. System 10 includes a plurality of second power switches labeled 410, 420, . . . , and 4N0, each of which is configured for coupling to one of the corresponding plurality of LED loads 310, 320, . . . , and 3N0, etc.

In FIG. 1, an integrated circuit controller 200 includes a voltage controller 201 configured to control the first power switch 500 to control an output voltage to each of LED loads 310, 320, . . . , and 3N0. A current controller includes a plurality of current control circuits 210, 220, . . . , and 2N0. Each of the current control circuits is configured for coupling to each of the plurality of second power switches to control a current through each of the LED loads 310, 320, . . . , and 3N0. In a specific embodiment, integrated circuit controller 200 is provided in a low-voltage integrated circuit chip, and the first power 500 switch and the plurality of second power switches 410, 420, . . . , and 4N0 are high-voltage devices external to the low-voltage integrated circuit chip. Depending on the embodiment, the low-voltage integrated circuit chip may be configured to operate at, for example, 5V or 3.3V. And the high-voltage devices may be rated for 20V-50V, 100V-300V, or even higher voltages.

As shown in FIG. 1, system 10 also includes a protection circuit 202 that are designed for protection against various anomalous operating conditions. Such conditions can include, for example, short circuit between a positive terminal of an LED load to a ground terminal, a short circuit between a negative terminal of an LED load to a ground terminal, a short circuit between a positive terminal and a negative terminal of an LED load, an open circuit in an LED load, and a short circuit in an LED load. When LED loads 300 is under condition of short circuit or open circuit, protection circuits 202 will operate correspondingly.

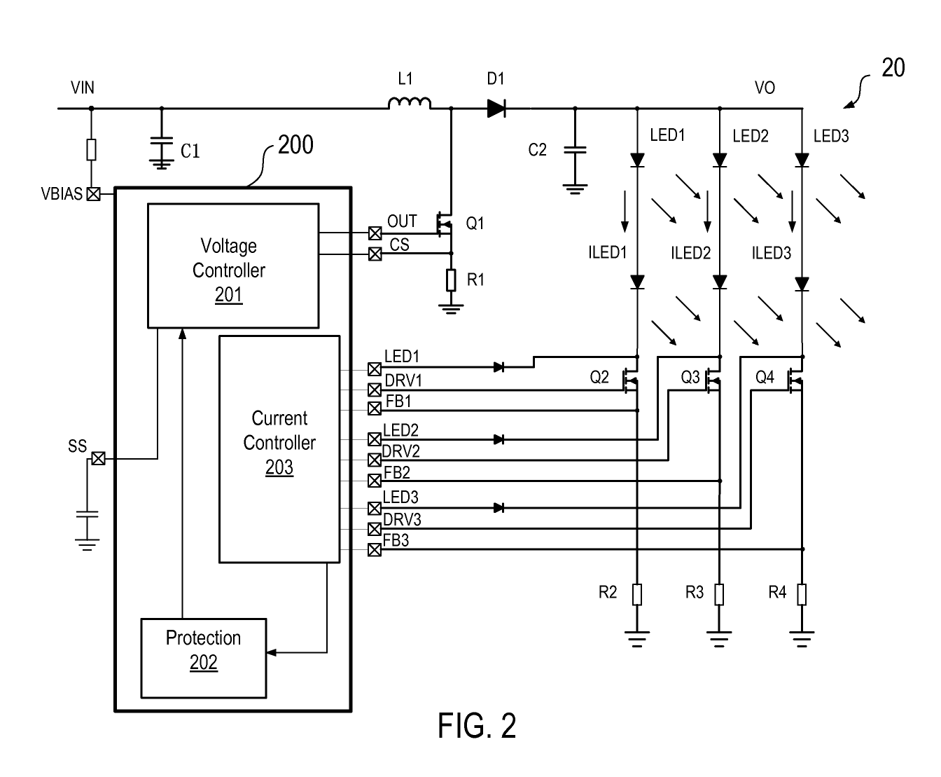

FIG. 2 is a simplified schematic diagram illustrating an LED backlight system 20 according to an embodiment of the present invention. System 20 can be a specific embodiment of the LED backlight system 20 in FIG. 1. As shown in FIG. 2, LED backlight system 20 includes a plurality of LED (light-emitting diode) loads (only three are shown and labeled LED1, LED2, and LED3). Each of the LED loads includes multiple light-emitting diodes connected in series. System 20 also includes power supply control system for driving the light-emitting diode (LED) loads. The power supply control system includes an integrated circuit controller 200, a first power switch Q1, and a plurality of second power switches (again, only three are shown and labeled Q2, Q3, and Q4).

In FIG. 2, the first power switch Q1 is coupled to a voltage source which, in this particular embodiment, includes DC input voltage source Vin, capacitor C1, inductor L1, and diode D1. Each of the second switches Q2-Q4 are for coupling to one of a corresponding plurality of LED loads LED1-LED3. As shown in FIG. 2, currents ILED1-ILED3 flow through the respective LED loads.

As shown in FIG. 2, power supply controller 200 is provided in an integrated circuit chip. Controller 200 includes one or more first terminal, e.g. OUT and CS, for coupling to first power switch Q1 that is external to the integrated circuit chip 200 and is coupled to a DC voltage source Vin. Controller 200 also includes multiple second terminals, e.g., LED1-LED3, DRV1-DRV3, and FB1-FB3, etc. for coupling to a plurality of second power switches, e.g., Q2, Q3, and Q4, etc., that are external to integrated circuit chip 200. Each of the plurality of second power switches are coupled to one of a corresponding plurality of LED loads, LED1-LED3, etc.

In FIG. 2, a voltage controller 201 is configured to control power switch Q1 to provide a constant output voltage to each of the LED loads. A current controller 203 is configured for coupling to each of the second power switches, e.g., Q2-Q4, to provide a constant current to each of the LED loads. The currents through switches Q2-Q4 are sensed at resistors R2-R4, respectively. Current controller 203 includes a current control circuit for controlling each of the plurality of second power switches. In an embodiment, each current control circuit includes a comparator circuit for comparing a reference voltage with a sensed voltage at a resistor (R2-R4) coupled to the respective second power switch.

In an embodiment, integrated circuit controller chip 200 has connection pins for connecting to three terminals of each of the plurality of second power switches Q2-Q4. In the embodiment shown in FIG. 2, the power switches are MOS power transistors, each having thee terminals, i.e., source, gate, and drain terminals. In alternative embodiments, the power switches can be bipolar transistors, and the three terminals are the collector, base, and emitter terminals. In an embodiment, integrated circuit controller 200 is provided in a low-voltage integrated circuit chip, and the power switches, Q1-Q4, etc., are high-voltage devices external to the low-voltage integrated circuit chip. In an embodiment, controller also includes a VBIAS pin for receiving external power supply and an SS pin for a soft start function.

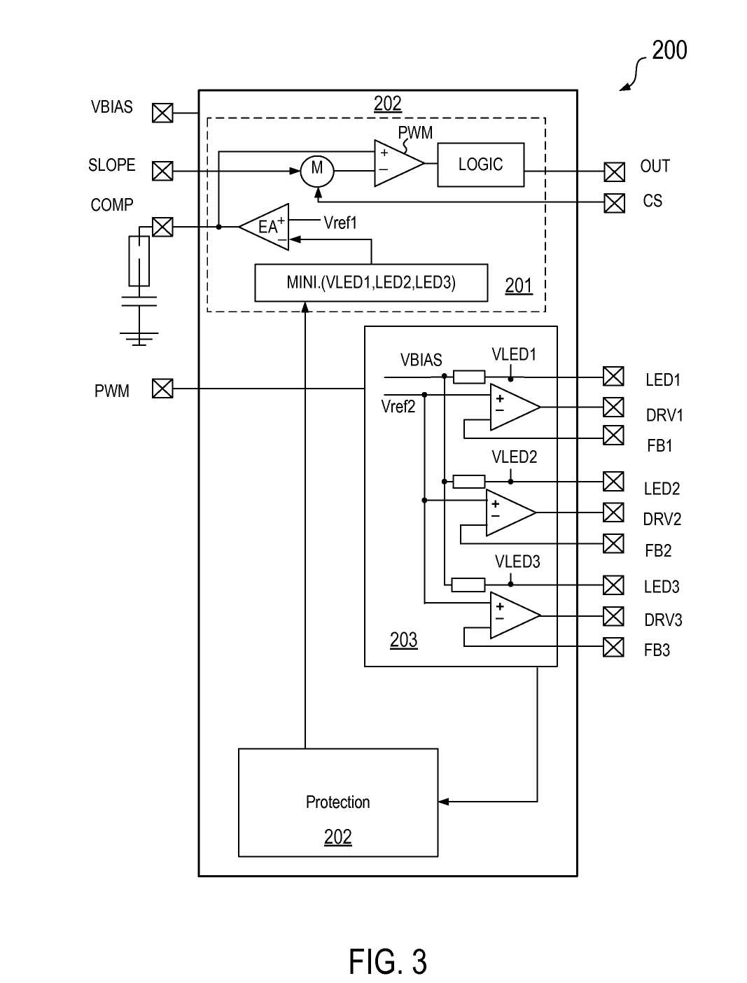

FIG. 3 is a simplified schematic diagram illustrating an example of integrated circuit power supply controller chip 200 of FIG. 2 according to an embodiment of the present invention. In addition to the features of controller 200 described above, FIG. 3 shows that voltage controller 201 includes a PWM (pulse width modulation) control circuit and an error amplifier EA which receives as inputs a reference signal Vref1 and voltage signals from the LED loads. Current controller 203 includes three current control circuits, each of which has a comparator that compares a feedback signal (FB1-FB3) with a second reference signal Vref2. Current controller 200 also receives voltage signals from the LED loads, e.g., VLED1-VLED3. Current controller 203 can also receive external controller signals, such as the PWM signal shown in FIG. 3.

As shown in FIG. 3, protection circuit 202 is coupled to both voltage controller 201 and current controller 203. Protection circuits 202 is configured for detecting anomalous operating conditions, such as:

short circuit between a positive terminal of an LED load to a ground terminal;

short circuit between a negative terminal of an LED load to a ground terminal;

short circuit between a positive terminal and a negative terminal of an LED load;

open circuit in an LED load; and

short circuit in an LED load.

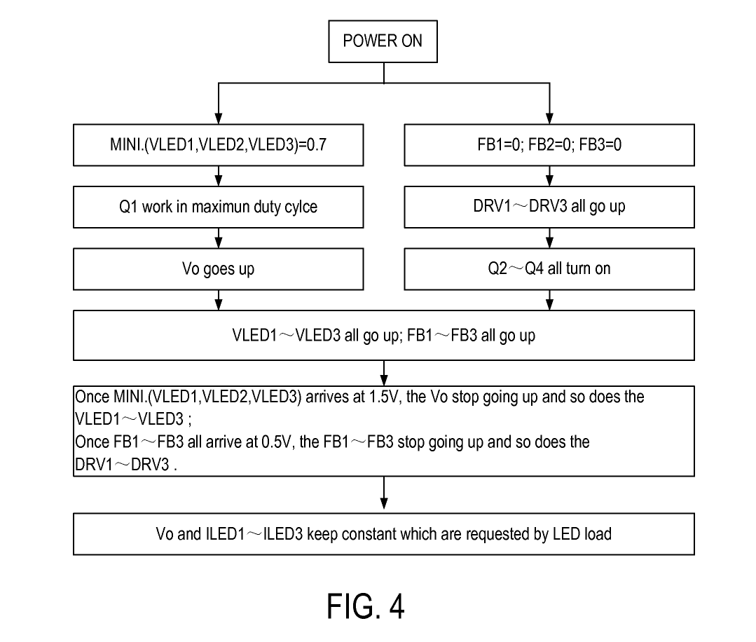

FIG. 4 is a simplified flowchart illustrating a method for driving an LED load according to an embodiment of the present invention. The flow chart shows exemplary operations of driving LED loads from start up, with reference to FIGS. 2 and 3. At power on, the voltages at FB1-FB3 pins and LED1-LED3 pins are both low, and the errors between the voltages and the internal reference voltages (e.g., 0.5V and 1.5V respectively) compared by the error-amplifiers provides a corresponding voltage at DRV1-DRV3 pin and OUT pin in order to control Q2-Q4 and Q1. The current match among ILED1-ILED3 in the LED loads is determined by the internal reference voltage and voltages sampled at external resistors R2-R4. When the brightness of LED loads is adjusted, the high voltage is sustained by high voltage devices Q2-Q4, and the integrated circuit controller can be protected from high voltages and damages. When an LED load is under a short circuit condition, the integrated circuit controller can detect the fault mode and shut down the system for safety. The short circuit conditions may include short circuit between a positive terminal of an LED load to a ground terminal, short circuit between a negative terminal of an LED load to a ground terminal, short circuit between a positive terminal and a negative terminal of an LED load, open circuit in an LED load, or short circuit in Schottky diode.

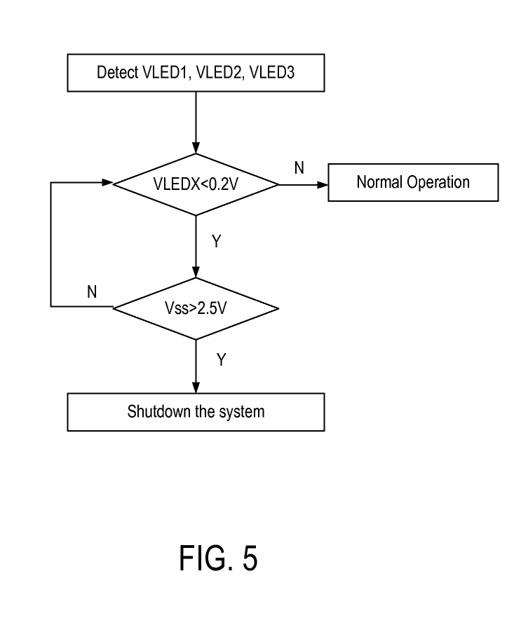

FIG. 5 is a simplified flowchart illustrating a method for short-circuit protection according to an embodiment of the present invention. As shown in FIG. 2, the power supply includes inductor L1 and diode D1, which can be a Schottky diode. When the Schottky diode is in short circuit, the output voltage VO will go low, and so will the voltages at the LED1-LED3 pins Once the voltages at LED1-LED3 pins are lower than a pre-sett value (for example, 0.2V), and the voltage at a soft start pin (SS pin) is higher than a pre-set value (e.g., 2.5V), then the protection circuit will be activated and shut down the system.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A power supply control system for driving light-emitting diode (LED) loads, the system comprising:
a first power switch for coupling to a voltage source;
a plurality of second power switches, each configured for coupling to one of a corresponding plurality of LED loads, each of the LED loads including multiple light-emitting diodes (LEDs) connected in series; and
an integrated circuit controller including:
a voltage controller configured to control the first power switch to provide an output voltage to each of the LED loads; and
a current controller configured for coupling to each of the plurality of second power switches to provide a current through each of the LED loads;
wherein the integrated circuit controller is provided in a low-voltage integrated circuit chip, and the first power switch and the plurality of second power switches are high-voltage devices external to the low-voltage integrated circuit chip.

2. The system of claim 1, wherein the current controller comprises a current control circuit for controlling each of the plurality of second power switches.

3. The system of claim 2, wherein each current control circuit comprises a comparator circuit for comparing a reference voltage with a sensed voltage at a resistor coupled to the respective second power switch.

4. The system of claim 1, wherein the low-voltage integrated circuit chip comprises connection pins for connecting to three terminals of each of the plurality of second power switches.

5. The system of claim 4, wherein the second power switches are MOSFETs, and the three terminals comprise the drain terminal, the gate terminal, and the source terminal.

6. The system of claim 4, wherein at least one of the second power switches is a bipolar transistor, and the three terminals are the collector terminal, the base terminal, and the emitter terminal.

7. The system of claim 1, wherein the plurality of LED loads are configured for providing backlight for a liquid crystal display (LCD) panel.

8. The system of claim 1, further comprising protection circuits configured for detecting the following conditions:
short circuit between a positive terminal of an LED load to a ground terminal;
short circuit between a negative terminal of an LED load to a ground terminal;
short circuit between a positive terminal and a negative terminal of an LED load;
open circuit in an LED load; and
short circuit in an LED load.

9. The system of claim 1, wherein the voltage controller comprises a pulse width modulation (PWM) control circuit.

10. A power supply controller provided in an integrated circuit chip, the power supply controller comprising:
one or more first terminals for coupling to a first power switch that is external to the integrated circuit chip and is coupled to a DC voltage source;
multiple second terminals for coupling to a plurality of second power switches that are external to the integrated circuit chip, each of the plurality of second power switches being coupled to one of a corresponding plurality of loads;
a voltage controller configured to control the first power switch to provide a constant output voltage to each of the plurality of loads; and
a current controller configured for coupling to each of the plurality of second power switches to provide a constant current to each of the plurality of loads.

11. The controller of claim 10, wherein the power supply controller is provided in a low-voltage integrated circuit chip, and the first power switch and the plurality of second power switches are high-voltage devices external to the low-voltage integrated circuit chip.

12. The controller of claim 10, wherein the current controller comprises a control circuit for controlling each of the plurality of second power switches.

13. The controller of claim 12, wherein each current circuit comprises a comparator circuit for comparing a reference voltage with a sensed voltage at a resistor coupled to the respective second power switch.

14. The controller of claim 10, wherein the low-voltage integrated circuit chip comprises connection pins for connecting to three terminals of each of the plurality of second power switches.

15. The controller of claim 10, wherein the plurality of LED loads are configured for providing backlight for a liquid crystal display (LCD) panel.

16. The controller of claim 10, further comprising protection circuits configured for detecting the following conditions:
short circuit between a positive terminal of an LED load to a ground terminal;
short circuit between a negative terminal of an LED load to a ground terminal;
short circuit between a positive terminal and a negative terminal of an LED load;
open circuit in an LED load; and
short circuit in an LED load.

17. The controller of claim 10, wherein the voltage controller comprises a pulse width modulation (PWM) control circuit.

18. An LED (light-emitting diode) backlight system, comprising;
a plurality of LED (light-emitting diode) loads, each of the LED loads including multiple light-emitting diodes connected in series;
a first power switch for coupling to a voltage source;
a plurality of second power switches, each configured for coupling to one of the plurality of LED loads; and
an integrated circuit controller including a voltage controller and a current controller, wherein:
the voltage controller is configured to control the first power switch to provide an output voltage to each of the LED loads; and
the current controller is configured for coupling to each of the plurality of second power switches to provide a current through each of the LED loads;
wherein the integrated circuit controller is provided in a low-voltage integrated circuit chip, and the first power switch and the plurality of second power switches are high-voltage devices external to the low-voltage integrated circuit chip.

19. The system of claim 18, wherein the current controller comprises a control circuit for controlling each of the plurality of second power switches, and each current circuit comprises a comparator circuit for comparing a reference voltage with a sensed voltage at a resistor coupled to the respective second power switch.

20. The system of claim 18, wherein the low-voltage integrated circuit chip comprises connection pins for connecting to three terminals of each of the plurality of second power switches.

21. The system of claim 18, wherein the voltage controller comprises a pulse width modulation (PWM) control circuit.

22. The system of claim 18, further comprising protection circuits configured for detecting the following conditions:
short circuit between a positive terminal of an LED load to a ground terminal;
short circuit between a negative terminal of an LED load to a ground terminal;
short circuit between a positive terminal and a negative terminal of an LED load;
open circuit in an LED load; and
short circuit in an LED load.
